(19) United States
(12) Patent Application Publication
(10) Pub. No.: US 2018/0127045 A1
(43) Pub. Date: May 10, 2018

(54) SELF-BALANCING POWERED UNICYCLE DEVICE

(71) Applicant: Timur Artemev, Haslemere, Surrey (GB)

(72) Inventor: Timur Artemev, Haslemere, Surrey (GB)

(21) Appl. No.: 15/573,336

(22) PCT Filed: May 10, 2016
(86) PCT No.: PCT/GB2016/051331

§ 371 Date: Nov. 10, 2017

(30) Foreign Application Priority Data
May 13, 2015 (GB) 1508170.6

(51) Int. Cl. B62K 1/00; B60L 11/18; B60L 15/20; B62K 11/00

(52) U.S. Cl. CPC B62K 1/00; B60L 11/1877; B60L 15/20; B60L 2260/34; B60L 2200/16; B60L 2240/423; B60L 2240/461; B62K 11/007

(57) ABSTRACT

A self-balancing powered unicycle (100) is disclosed. The unicycle comprises: a single primary wheel (120) adapted to rotate about a primary axis of rotation (125); a balance control system adapted to maintain fore-aft balance of the unicycle device by controlling rotation of the primary wheel; a foot platform (165) for supporting a user of the unicycle device; and at least one auxiliary support (195) adapted to rotate about an auxiliary axis of rotation, wherein the auxiliary axis of rotation is adapted to be angled with respect to the primary axis of rotation.

### FIELD OF INVENTION

The present invention relates to powered single-wheeled devices and more particularly to powered unicycles with self-balancing functionality.

### BACKGROUND TO THE INVENTION

Powered self-balancing vehicles for use while standing are known. Such vehicles include two-wheeled vehicles and single-wheeled vehicles (i.e. unicycles).

In a powered self-balancing unicycle, an electronic or mechanical system that controls the wheel in the appropriate direction is typically used to achieve fore-and-aft balance. This type of automatic fore-and-aft balance technology is well known and described, for example, in U.S. Pat. No. 6,302,230. A sensor and electronic equipment are typically provided. Information detected by the sensor and the electronics is relayed to a motor. The motor drives the wheel in the appropriate direction and at sufficient speed to maintain fore-and-aft balance.

Known embodiments of a powered self-balancing unicycle do not include a handle bar supported by a shaft. For example, U.S. patent application Ser. No. 12/281,101 presents a single wheel, coupled to a frame to which two platforms (one on each side of the wheel) are attached.

### SUMMARY OF THE INVENTION

According to a first aspect of the invention, there is provided a self-balancing powered unicycle device, comprising: a single primary wheel adapted to rotate about a primary axis of rotation; a balance control system adapted to maintain fore-aft balance of the unicycle device by controlling rotation of the primary wheel; a foot platform for supporting a user of the unicycle device; and at least one auxiliary support adapted to rotate about an auxiliary axis of rotation, wherein the auxiliary axis of rotation is adapted to be angled with respect to the primary axis of rotation.

There is proposed a self-balancing powered unicycle comprising an auxiliary support that is adapted to rotate about an auxiliary axis of rotation which is angled with respect to the axis of rotation of the single primary wheel. The auxiliary support is therefore adapted to be able to rotate in a different direction from that of the main unicycle wheel, and as a result, the auxiliary support may provide a supplementary contact or support point upon which the unicycle may be supported when it is oriented in particular way (e.g. tilted or inclined from vertical by more than a certain amount). By being rotatable the auxiliary support may be used to provide a supporting pivot point for enabling the unicycle to turn about a small/tight turning circle.

The auxiliary support may also be used for conveying the unicycle in a direction that differs from the running direction of the primary wheel. For example, the unicycle may be supported solely on the auxiliary support (e.g. without the primary wheel contacting the ground) and then pulled or pushed along on the auxiliary support (like a conventional trolley luggage arrangement for example).

The auxiliary support may be adapted to only contact a ground supporting surface when the primary wheel is tilted from vertical by more than 10 degrees. Thus, the auxiliary support may be adapted to differ substantially from conventional ‘stabilizer’ arrangements which are typically arranged to contact the ground when the unicycle is in a generally upright/vertical orientation, or when only angled from vertical by a few degrees, so as to help maintain the generally upright/vertical orientation and help balance (e.g. stabilize) the unicycle laterally. Unlike a conventional stabilizer, a proposed auxiliary support is arranged to only come into contact with the horizontal ground surface when the unicycle is titled significantly from vertical (e.g. by more than 10°, preferably by more than 15°, more preferably by more than 25°, and even more preferably by more than 30°), which may for example only occur when a user attempts to turn the unicycle sharply and thus intentionally leans the unicycle sideways by a significant amount. In such a situation, the auxiliary support may act as a support for preventing the unicycle from falling over in a sideways fashion and thus enable the unicycle to turn in a tighter fashion (e.g. with a smaller turning circle radius) than would otherwise be possible).

The auxiliary axis of rotation may be adapted to be rotatable about a supplementary axis which is angled with respect to the auxiliary axis of rotation. Further, the auxiliary axis of rotation may be adapted to be rotatable about the supplementary axis by 360°. Thus, the auxiliary support may be pivotable so that it can rotate in various directions (and not just forward and backwards in a single plane for example). The auxiliary support may therefore enable the unicycle to be highly maneuverable when supported and/or conveyed on the auxiliary support.

For example, the supplementary axis may be substantially perpendicular to the auxiliary axis of rotation. Thus, the auxiliary support may be pivoted such that is able to pivot around an axis which is substantially perpendicular to the axis around which it rotates. Put another way, the auxiliary axis (about which the auxiliary support is adapted to rotate) may be adapted to pivot, much like the arrangement of a front wheel of a conventional shopping cart/trolley for example).

The auxiliary axis of rotation may be adapted to be substantially perpendicular to the primary axis of rotation. A ‘running direction’ of the auxiliary support may therefore be 90° (i.e. at a right angle) from the normal running direction of the primary wheel of the unicycle. Thus, the auxiliary support may be adapted to support and/or convey the unicycle when it is titled on its side, preferably so that the primary wheel is raised so as to not contact the ground for example.

The auxiliary support may comprise a substantially spherical or circular wheel.

In embodiments, the auxiliary support may be adapted to be movable between a stowed configuration and an active position.

In the stowed configuration, the auxiliary support may be retracted into the housing or main body of the unicycle device (e.g. stowed away). In the active configuration, the auxiliary support may be arranged so as to be positioned or project outside of the housing or main body so that they are adapted to contact the ground when the unicycle is tilted from vertical by a predetermined significant amount. In other words, in the stowed configuration, the auxiliary support may be arranged so that it does not contact the ground when the unicycle is tilted from vertical by the amount by which the auxiliary support would contact the ground when in the active configuration. Thus, the auxiliary support may be movable between: (i) a stowed configuration wherein it is retracted against or inside the housing or body of the unicycle device; and (ii) an active configuration, wherein it is positioned or projects outwardly from/of the housing or body of the unicycle device. Accordingly, the auxiliary support may be foldable into a stowed configuration that narrows the profile of the unicycle device. In use, the auxiliary support may be moved to the active configuration.

By way of example, a telescoping actuator arrangement may be employed to move the auxiliary support between a stowed configuration and an active position.

Telescoping actuators are specialized linear actuators that may be used where space restrictions exist, mainly because their range of motion can be many times greater than the retracted (or unextended) length of the actuating member. A form of telescoping linear actuator is made of concentric tubes of approximately equal length that extend and retract like sleeves, one inside the other, such as a telescopic cylinder. Telescopic cylinders are a special design of hydraulic, electric or mechanical cylinders which provide a long output travel from a compact retracted length. Typically, the collapsed length of a telescopic cylinder may be 20 to 40% of the fully extended length depending on the number of stages. Some telescoping units may be manufactured with retracted lengths of under 15% of overall extended unit length. Thus, employment of a telescoping actuator may help to reduce the size (e.g. thickness, length or vertical profile) of the actuator arrangement when the auxiliary support is in either configuration, thereby allowing the unicycle device to have a slim body. In other words, embodiments may employ a telescoping actuator which helps to reduce the size and/or width of the unicycle device.

Such an actuator arrangement according to an embodiment may help to ensure that sufficient leverage can be generated to move the auxiliary support, while maintaining a slim-line design to ensure the unicycle can meet predetermined size, weight, height or volume requirements.

The telescoping actuator may, for example, further comprise: one or more hydraulic, electric or mechanical actuators adapted to move the auxiliary support between its stowed and active configuration.

In other embodiments, a simple mechanical lever arrangement may be used to move the auxiliary support between a stowed configuration and an active configuration. Further, or alternatively, one or more hydraulic, electric or mechanical actuators may be used to move the auxiliary support between a stowed configuration and an active configuration, and such actuators may be operated/controlled by a button/switch for example.

Embodiments may further comprise a retractable handle adapted to be movable between a retracted configuration and an extended configuration. Also, the retractable handle is adapted to be movable between a retracted configuration and an extended configuration so as to move the at least one auxiliary support between the stowed configuration and the active position.

Embodiments may therefore employ a simple and cheap arrangement that can be driven so as to move the auxiliary support between predefined configurations.

The auxiliary support may be mounted on the foot platform. Thus, the foot platform may be provided with an auxiliary support for contacting the ground when the unicycle is tilted from vertical by a significant extent (e.g. by more than 25°).

The at least one auxiliary support may comprise first and second rotatably mounted elements adapted to rotate about first and second auxiliary axes of rotation, respectively, wherein the first and second auxiliary axes of rotation are adapted to be angled with respect to the primary axis of rotation. Thus, the auxiliary support may comprise two wheels for example.

The unicycle device may further comprise: an entity presence detection system adapted to detect the presence of an entity on, at or near a part of, the powered unicycle and provide an indication of detected entity presence; and a control system adapted to control operation of the auxiliary support based on the indication of detected entity presence from the entity presence detection system. Thus, an embodiment may provide an indication or signal which is used by a control system to alter operation of the auxiliary support upon occurrence of one or more predetermined conditions indicating an entity (such as a user) is present or not-present on the unicycle. Such embodiments may therefore enable quick and easy deployment from an off configuration (wherein the auxiliary support is in a stowed position, for example) to an on configuration (wherein the auxiliary support is in an active position, for example). This deployment may require little or no input from the user, but instead may be automatically achieved when the user is in close proximity with, or contacts) one or more predetermined parts of the unicycle.

Embodiments may enable the auxiliary support(s) to automatically move to an active configuration if the user alights or dismounts from the unicycle (e.g. by intentionally stepping off the foot platform(s)). Embodiments may therefore facilitate multiple functions, including the provision of an automatic auxiliary support deployment mode, the provision of quick start-up/deployment, and the provision of an automatic-stowing safety feature. Embodiments may thus provide not only for improved user interaction, but also for improved portability.

According to another embodiment, the entity presence detection system may comprise a load sensing system adapted to determine a loading applied to at least one part of the powered unicycle. Further, the load sensing system may be adapted to determine at least one of: a deflection of the wheel axle; a compressive force applied to the wheel axle; a deflection of the at least one foot platform; a tensile force applied to the at least one foot platform; and a compressive force applied to the at least one foot platform, so as determine a loading applied to the at least one foot platform of the powered unicycle. In such embodiments, operation of the actuator arrangement may be based on a value of the loading applied to one or more of its parts. In some embodiments, the entity presence detection system may comprise a processing unit adapted to process signals in accordance with an algorithm to determine if an entity is present on, at or near a part of the powered unicycle. By way of example, such an algorithm may be adapted to determine if the signals from the drive arrangement and/or the balance control system exhibit a predetermined characteristic indicating the presence or non-presence of a user on the powered unicycle. The signals from the drive arrangement and/or the balance control system may comprise information relating to at least one of: casing orientation; inclination or angle of a part of the unicycle; value of compressive force applied to at least part of a foot platform; accelerometer data; gyroscope data; motor torque; speed of wheel rotation; and a motor drive voltage.

According to yet another embodiment, the entity presence detection system may comprise a vibration sensor adapted to detect a frequency of vibration of at least one part of the powered unicycle. The entity presence detection system may be adapted to determine the presence or non-presence of a user based on if a detected frequency of vibration of at least one part of the powered unicycle is within a predetermined range.

For the avoidance of doubt, reference to a single primary wheel should be taken to mean the generally circular unit that is positioned between the legs of a user and adapted to rotate about an axis to propel the unicycle in a direction during use. The single wheel may therefore be formed from one or more tyres and/or hubs that are coupled together (via a differential, for example). For example, an embodiment may comprise a single hubless wheel having a single hubless rim with a plurality of separate tyres fitted thereon. Alternatively, an embodiment may comprise a single hubless wheel formed from a plurality of hubless rims (each having a respective tyre fitted thereon), wherein the plurality of hubless rims are coupled together via a differential bearing arrangement.

Embodiments may provide a self-balancing powered unicycle that can alter the configuration of its auxiliary support(s), and such alteration may be driven by drive means (such as a motor and/or mechanical linkage for example) rather than being undertaken manually. For example, an actuator arrangement that moves the auxiliary support between a deployed and stowed configuration may be automatically enabled or disabled to facilitate rapid and simple operation of the unicycle.

Also, the balance control system of an embodiment may be adapted to maintain or assist pivotal balance of the unicycle device about an inclined supplementary axis that is titled from vertical by controlling rotation of the wheel when the unicycle device is supported only by the at least one auxiliary support (such that the wheel is not in contact with the ground surface for example).

### BRIEF DESCRIPTION OF THE DRAWINGS

An example of the invention will now be described with reference to the accompanying diagrams, in which:

FIG. 1 is an isometric view of an embodiment of a powered unicycle device in a closed configuration;

FIG. 2 is an exploded diagram of components internal to the casing of FIG. 1,

FIGS. 3A & 3B are side and front elevations, respectively, of the embodiment of FIG. 1, wherein the casing is moving between a closed and open configuration;

FIGS. 4A & 4B are side and front elevations, respectively, of the embodiment of FIG. 1, wherein the casing is in an open configuration and the foot platforms are in a stowed configuration;

FIGS. 5A & 5B are side and front elevations, respectively, of the embodiment of FIG. 1, wherein the casing is in an open configuration and the foot platforms are in an active configuration;

FIG. 6 is a front elevation of a unicycle device according to another embodiment of the invention;

FIG. 7 depicts the embodiment of FIG. 6 titled sideways from vertical so that the first support wheel contacts the generally horizontal ground/supporting surface;

FIG. 8 depicts a modification to the embodiment of FIGS. 6-7, wherein the device is tilted sideways so that the first support wheel contacts the generally horizontal ground/supporting surface and so that the wheel is separated vertically from the generally horizontal ground/supporting surface 250; and

FIG. 9 is an isometric view of another embodiment of a powered unicycle device, wherein the auxiliary support is in an active position.

### DETAILED DESCRIPTION

Proposed is self-balancing powered unicycle device having an auxiliary support that is adapted to rotate about an auxiliary axis of rotation which is in a different direction from the axis of rotation of the single primary wheel. The auxiliary support is therefore adapted to be able to rotate in a different direction from that of the main unicycle wheel, and as a result, the auxiliary support may provide a supplementary contact or support point upon which the unicycle may be supported when it is oriented in particular way (e.g. tilted or inclined from vertical by more than 10° for example). The auxiliary support may be used to provide a supporting pivot point for enabling the unicycle to turn about a small/tight turning circle.

The auxiliary support may also be used for conveying the unicycle in a direction that differs from the running direction of the primary wheel. For example, the unicycle may tilted on its side so as to be supported solely on the auxiliary support (e.g. without the primary wheel contacting the ground) and then pulled or pushed along on the auxiliary support (like a two-wheeled suitcase for example).

The term vertical, as used herein, means substantially orthogonal to the generally horizontal ground surface upon which a unicycle may be ridden. The term lateral, as used herein, means substantially parallel to the generally horizontal ground surface. Also, terms describing positioning or location (such as above, below, top, bottom, etc.) are to be construed in conjunction with the orientation of the structures illustrated in the diagrams.

The diagrams are purely schematic and it should therefore be understood that the dimensions of features are not drawn to scale. Accordingly, the illustrated thickness of any of the components or features should not be taken as limiting. For example, a first component drawn as being thicker than a second component may, in practice, be thinner than the second component.

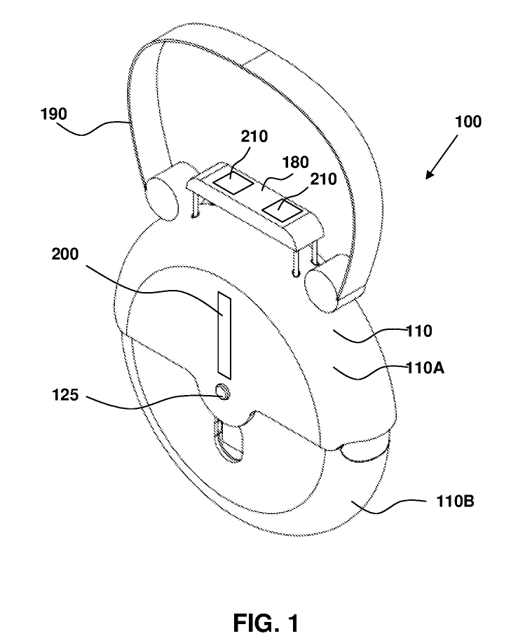

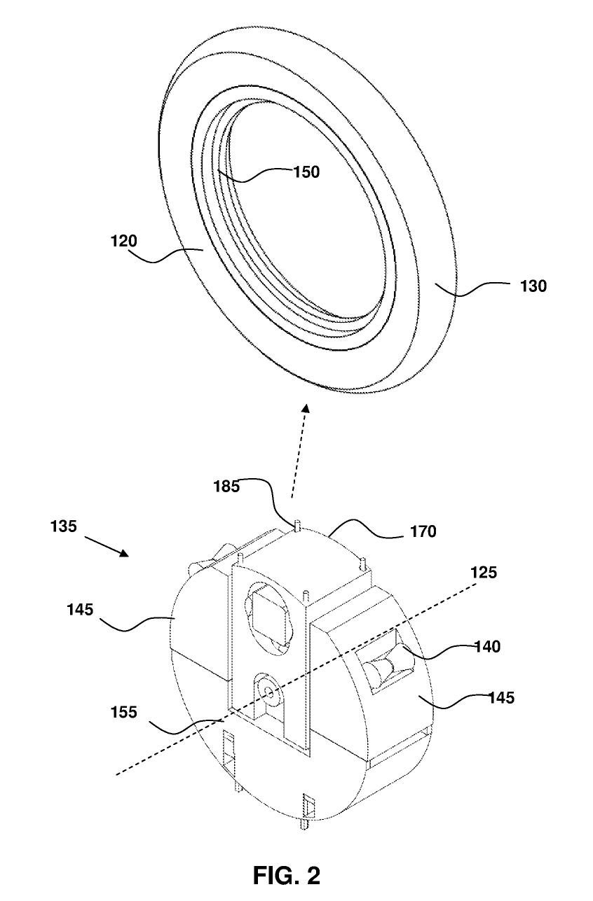

FIGS. 1-5 show one embodiment of a powered unicycle device 100. FIG. 1 shows the powered unicycle device 100 with a casing 110 in a closed configuration so that it encases a single wheel 120. Here, the casing 110 is formed from a first, upper portion 110A that covers the top (uppermost) half of the wheel 120, and a second, lower portion 110B that covers the bottom (lowermost) half of the wheel 120. FIG. 2 illustrates an exploded view of components internal to the casing 110, namely a wheel 120 and drive arrangement 135.

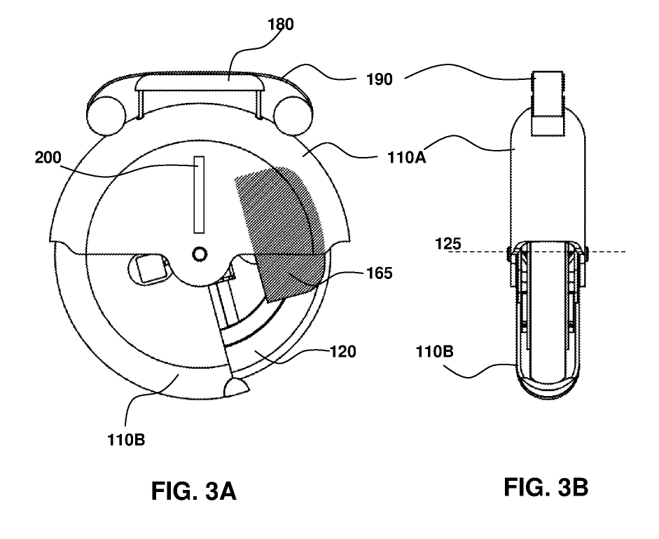

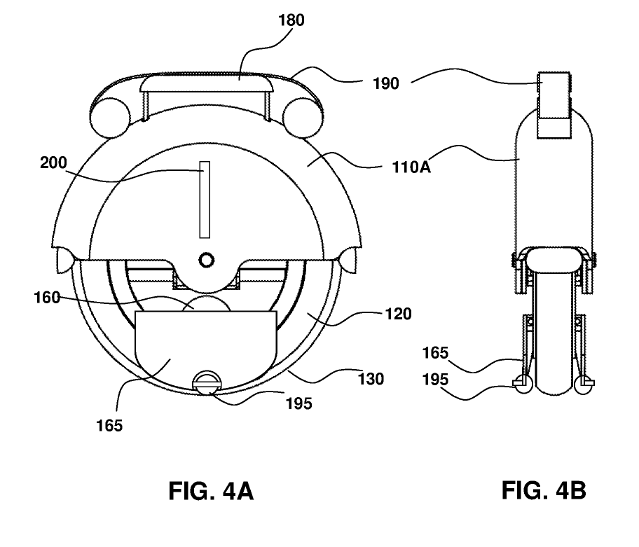

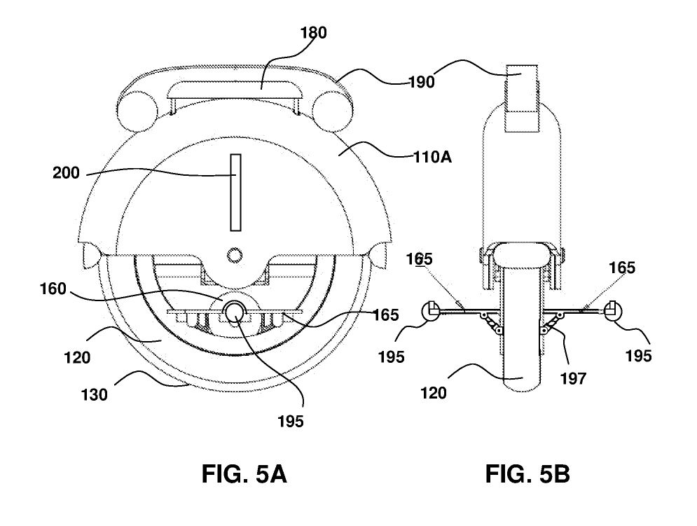

Referring back to FIG. 1, the wheel 120 spins about a central axis 125. The first, upper portion 110A of the casing is retained in a fixed position relative to the central axis 125, whereas the second, lower portion 110B of the casing is adapted to rotate about the central axis 125. Rotation of the second lower portion 110B about the central axis 125 moves the casing between closed and open configurations (as illustrated by FIGS. 3-4). In the closed configuration (shown in FIG. 1), the casing 110 encloses the wheel 120 so that the outer rim 130 of the wheel 120 is not exposed. In the open configuration (shown in FIGS. 4-5), the outer rim 130 of the wheel 120 is exposed so that it can contact a ground surface.

Referring now to FIG. 2, rotation of the single wheel 120 is driven by a drive arrangement 135 according to an embodiment. The drive arrangement 135 includes guide wheels 140 attached to an outwardly facing side of respective batteries 145. In this embodiment, there are two pairs of angled guide wheels 140, wherein the two guide wheels in each pair share are tapered or conical such that they have a sloped surface which is not perpendicular to the radial plane of the single wheel 120. Put another way, the contact surface of each guide wheel is inclined with respect to the radial plane of the single wheel 120. The guide wheels 140 of each pair are also positioned spaced apart to provide a gap between the two guide wheels of a pair.

A rib 150 is provided around the inner rim of the wheel 120 and fits into the gap between the two guide wheels 140 in each pair. The guide wheels 140 are therefore adapted to contact with the inner rim of wheel 120 where they spin along with wheel 120 and hold wheel 120 in place by way of the rib 150. Of course, it will be appreciated that other arrangements, including those with only one guide wheel per battery 145, are possible.

The batteries 145 are mounted on a motor 155 which drives a pair of drive wheels 160 positioned at the lowermost point along the inner rim of the wheel 120. The batteries 145 supply power to motor 155 and, this embodiment, there are two batteries in order to create a balanced distribution of volume and weight. However, it is not necessary to employ two batteries 145. Also, alternative energy storage arrangements may be used, such as a flywheel, capacitors, and other known power storage devices, for example.

The drive arrangement 135 is adapted to be fitted inside the wheel. In other words, the drive arrangement is sized and shaped so that it can be positioned in the void define by the inner rim of the wheel 120. Further, the drive arrangement 135 is movable between a locked configuration and an unlocked configuration.

In the locked configuration, when fitted inside the wheel 120, the drive arrangement 135 engages with the rim of the wheel 120 to prevent its removal from the wheel. Here, in the embodiment shown, the guide wheels 140 contact the inner rim of wheel 120 and hold wheel 120 in place by way of the rib 150 when the drive arrangement is in the locked configuration.

In the unlocked configuration, when fitted inside the wheel 120, the drive arrangement 135 disengages with the rim of the wheel 120 to permit its removal from the wheel. Here, in the embodiment shown, the drive arrangement contracts in size when moved from the locked configuration to the unlocked configuration so that the guide wheels 140 no longer contact the inner rim of wheel 120 and no longer hold the wheel 120 in place by way of the rib 150. Such reduced size (e.g. diameter) of the drive arrangement 135 when in the unlocked configuration thus enables the drive arrangement 135 to be removed from the wheel 120.

It will therefore be understood that the drive arrangement 135 of the illustrated embodiment can be quickly and easily connected or removed to/from the wheel 120 for repair or replacement, for example. Arranging the drive arrangement 135 in the unlocked configuration permits its removal or fitting from/to the wheel 120 (because, for example, its dimensions when in the unlocked configuration permit its fitting inside the wheel). When fitted inside the wheel 120, the drive arrangement can be arranged in the locked configuration so that it engages with the rim of the wheel 120 to prevent its removal (because, for example, its dimensions when in the locked configuration prevent the drive arrangement from being removed from the wheel).

When the drive arrangement 135 is fitted inside the wheel and in the locked configuration, a pair of drive wheels (not visible in FIG. 2) is adapted to contact the inner rim of the wheel 120. Here, the pair of drive wheels comprises first and second rollers that are inclined with respect to the radial plane of the wheel. By way of contact with the inner rim of the wheel 120, the drive wheels transmit torque from the motor 155 to the wheel 120. It will be understood that this drive system operates by friction and it may be preferable to avoid slippage between the drive wheels and the inner rim of wheel 120. Positioning the drive wheels at the lowermost point enables the weight of a user to provide a force which presses the drive wheels against the inner rim of the wheel 120, thereby helping to reduce or avoid slippage.

Referring to FIGS. 4-5, two foot platforms 165 are coupled to the second, lower portion 110B of the casing 110, with one on each side of wheel 120. In the open configuration, the foot platforms 165 are movable between a stowed configuration, wherein the foot platforms are substantially parallel with the plane of the wheel (as shown in FIG. 4), and an active configuration, wherein the foot platforms are substantially perpendicular to the plane of the wheel (as shown in FIG. 5) so as to support a user's weight. Thus, in this embodiment, the foot platforms 165 are movable between: (i) a stowed configuration wherein they are flat against the side of the wheel and can be rotated (with the second, lower portion 110B of the casing) about the central axis 125 so as to be positioned inside (and covered by) the first, upper portion 110A of the casing; and (ii) an active configuration, wherein. Accordingly, the foot platforms 165 are upwardly foldable into a stowed configuration that narrows the profile of the unicycle 100 to aid in storage and carrying. In use, the foot platforms are moved to the active configuration, and the user stands with one foot on each platform 165.

The drive arrangement 135 includes a gyroscope or accelerometer system 170 which senses forward and backward tilt of the device in relation to the ground surface and regulates the motor 155 accordingly to keep the device upright. In this way, the user is provided a way of controlling the acceleration and deceleration of the unicycle by varying the pressure applied to various areas of the foot platforms 165. It also enables the unicycle to self-regulate its balance in the fore-and-aft plane.

When not in use, the foot platforms 165 are moved to the stowed configuration and then rotated (with the second, lower portion 110B of the casing) about the central axis 125 so as to move the casing to the closed configuration. Thus, in the closed configuration, the foot platforms 165 are stored inside the casing (covered by the first, upper portion 110A of the casing).

The embodiment of FIGS. 1-5 also comprises a lifting handle 180 coupled to the drive arrangement 135 via a plurality of rods 185. The lifting handle 180 is positioned at the top of the casing 110, above the wheel 120, and may be used to hold the unicycle 100 above the ground, for example to enable a user to lift, carry, convey or place the unicycle 100.

A retractable carrying strap 190 is also provided and attached to the top of the casing 100. The carrying strap 190 may be used to carry the unicycle 100, for example over the shoulder of user. A hook may be provided on the bottom of the case to create rucksack-like belts from the carrying strap 190. The carrying strap 190 may also be used to pull the unicycle 100, for example when the auxiliary supports (detailed below) are in contact with the ground/supporting surface).

The embodiment of FIGS. 1-5 further comprises an auxiliary support arrangement provided on the foot platforms 165. The actuator arrangement comprises first and second rotatably mounted elements 195 (in particular spherical balls) adapted to rotate freely in 3-dimensions. Thus the spherical balls 195 are each adapted to rotate about a respective auxiliary axis of rotation which is angled with respect to the (primary) central axis of rotation 125. Thus, the auxiliary support arrangement in this embodiment comprises two spherical wheels 195.

Each of the two spherical wheels 195 are adapted to rotate about an auxiliary axis of rotation which can freely pivot and rotate in 3-dimensions. The spherical wheels 195 are therefore adapted to be able to rotate in a different directions from that of the main unicycle wheel 120 (i.e. the central axis 125). The spherical wheels 195 are adapted to provide a supplementary contact or support point upon which the unicycle may be supported when it is oriented in particular way (e.g. tilted or inclined from vertical by more than a certain amount). By being rotatable, the spherical wheels 195 may be used to provide a supporting pivot point for enabling the unicycle to turn about a small/tight turning circle.

Also, the spherical wheels 195 can be used for conveying the unicycle in a direction that differs from the running direction of the primary wheel, for example in a lateral/sideways direction. By way of example, the unicycle may be tilted to the side so that it is supported solely on one of the spherical wheels 195 (e.g. without the wheel 120 contacting the ground) and then pulled or pushed along on the spherical wheels 195 (like a conventional trolley luggage arrangement for example).

Here, the spherical wheels 195 are arranged to only contact a ground supporting surface when the primary wheel is tilted from vertical by 45°. Unlike a conventional stabilizer, each spherical wheel is arranged to only come into contact with the horizontal ground surface when the unicycle is titled significantly from vertical (e.g. by 45° in this example). This may, for example, occur when a user attempts to turn the unicycle sharply and thus intentionally leans the unicycle sideways by 45°. In such a situation, the spherical wheel 195 can act as a support for preventing the unicycle from falling over in a sideways fashion and thus enable the unicycle to turn in a tighter fashion (e.g. with a smaller turning circle radius) than would otherwise be possible).

The embodiment of FIGS. 1-5 also comprises an entity presence detection system 200 adapted to detect the presence of a user. More specifically, in this embodiment, the entity presence detection system 200 comprise a proximity sensor 200 situated on each side of the first, upper portion 110A of the casing above the central axis 125. Each proximity sensor 200 is adapted to detect the existence of a user's leg in close proximity with the proximity sensor 200. In order to do this, the proximity sensors 200 may, for example, employ infrared reflection, ultrasonic sensing, and/or and light detection principles to detect if/when a user's leg is positioned in close proximity with the proximity sensor (e.g. contacting the first, upper portion 110A of the casing).

The proximity sensors 200 provide a signal indicating whether or not a user's presence it detected. This signal is provided to a control system (not shown) which is to control operation of the powered unicycle, by controlling the drive arrangement 135 for example. Based on an indication of detected user presence provided by the signal(s) from the proximity sensors 200, the control system controls operation of the powered unicycle.

Here, the entity presence detection system 200 is also adapted to trigger an activating system which moves the casing between the closed and open configurations. More specifically, the entity presence detection system 200 further comprises proximity sensors 210 incorporated into the handle 180 which are adapted to detect when a user's hand contacts the upper surface of the handle (e.g. when a user grips the handle 180). When one of the proximity sensors 210 incorporated into the handle 180 detects a user's hand contacting the upper surface of the handle 180, it provides an activation signal which triggers the activating system which, in turn, causes the second, lower portion 110B of the casing to rotate about the central axis to move from the closed configuration to the open configuration. This process of rotating the second, lower portion 110B of the casing from the closed configuration to the open configuration is depicted by FIGS. 3-4.

Furthermore, the entity presence detection system 200 is also adapted to trigger an actuator arrangement which moves the foot platforms between the stowed configuration and active configurations. More specifically, the entity presence detection system 200 provides an activation signal which triggers the actuator arrangement which, in turn, causes first and second telescoping actuators 197 to extend so as to pivotally move the foot platforms 165 from the stowed configuration to the active configuration. This process of outwardly folding the foot platforms 165 from the stowed configuration to the active configuration is depicted by FIGS. 4-5.

It will therefore be understood that, in this embodiment, the proximity sensors 210 in the lifting handle 180 may be used to initiate the activating system and move the casing from the closed configuration to the open configuration, and to subsequently initiate the actuator arrangement to move the foot platforms 165 from the stowed configuration to the active configuration. Thus, when a user holds the unicycle 100 by the handle, the proximity sensors 210 trigger the activating system and then the actuator arrangement. In response to this trigger, the activating system moves the casing to the open configuration (depicted in FIG. 4) so that the lowermost portion of the wheel is exposed and can be brought into contact with a ground surface, and then the actuator moves the foot platforms 165 to the active configuration (depicted in FIG. 5) so that they project outwardly from the side of the wheel to provide support surfaces for the feet of a user. In other words, when lifted by the lifting handle 180, the unicycle may be arranged in an open and active configuration ready for deployment (e.g. placement on a ground surface).

When the user no longer desires to use the unicycle, the user grips the lifting handle to lift the unicycle from the ground. This results in the proximity sensors 210 triggering the actuator arrangement once again which then causes the foot platforms to move from the active configuration (shown in FIG. 5) to the stowed configuration (shown in FIG. 4), and then subsequently causes the activating system to move the casing from the open configuration (depicted in FIG. 4) to the closed configuration (depicted in FIG. 1).

Although the above embodiment has been described above employing a telescoping actuators which are formed from a plurality of nesting, telescoping sections that are adapted to extend and retract like sleeves, it will be understood that other embodiments may employ other types of telescoping actuators. For example, other embodiments may employ telescoping actuators which use actuating members that act as rigid linear shafts when extended, but break that line by folding, separating into pieces and/or uncoiling when retracted. Examples of such an alternative telescoping actuator include: a helical band actuator; a rigid belt actuator; a rigid chain actuator; and a segmented spindle.

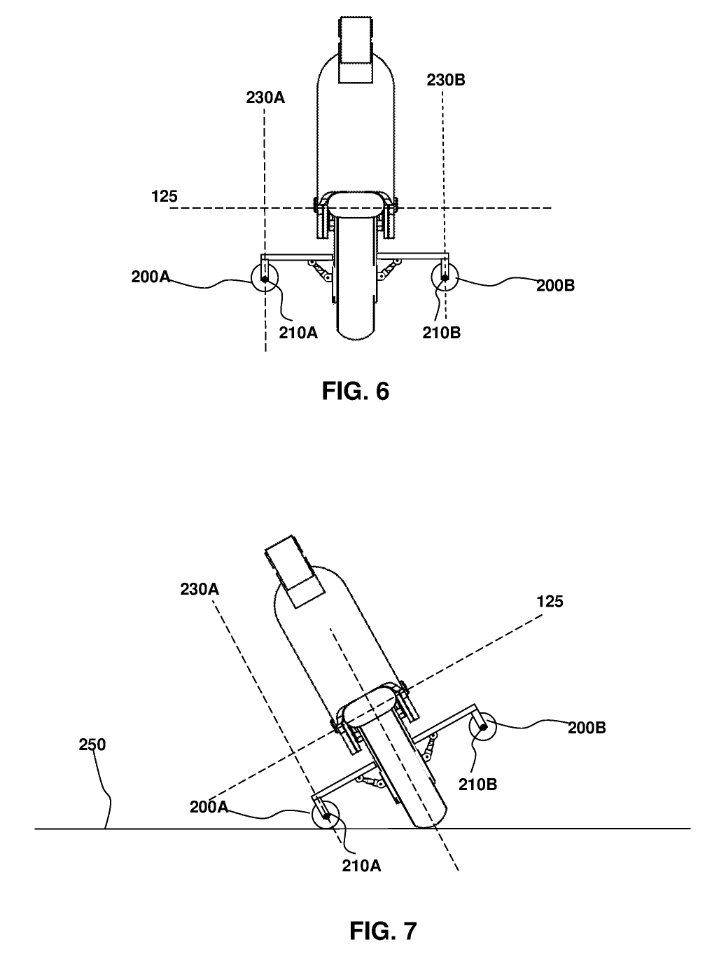

Turning now to FIGS. 6-7, there is depicted a unicycle device according to another embodiment of the invention. The embodiment of FIGS. 6-7 is similar to the embodiment of FIGS. 1-5. However, in the embodiment of FIGS. 6-7, the auxiliary support arrangement comprises first 200A and second 200B support wheels which are adapted to rotate about first 210A and second 210B auxiliary axes of rotation, respectively. The first support wheel 200A is coupled to the left 165A foot platform and the second support wheel 200B is coupled to the right 165B foot platform.

The first 210A and second 210B auxiliary axes of rotation are angled with respect to the central axis of rotation 125. More specifically, the first 210A and second 210B auxiliary axes of rotation are substantially perpendicular to the central axis of rotation 125. Also, each of the first 210A and second 210B auxiliary axes of rotation is rotatable about a supplementary axis 230A,230B which is angled with respect to the respective auxiliary axis 210A,210B of rotation. Here, each supplementary axis 230A,230B is perpendicular to its respective auxiliary axis of rotation 230A,230B. More specifically, the first 210A and second 210B auxiliary axes of rotation are rotatable about their respective supplementary axis 230A,230B by 360°. Thus, each support wheel 200A, 200B is pivotable so that it can rotate in various directions (and not just forward and backwards in a single plane for example).

As depicted in FIG. 7, the first support wheel 200A is adapted to contact the generally horizontal ground/supporting surface 250 when the wheel 120 is tilted sideways from vertical by approximately 15-20°. Thus, unlike a conventional stabilizer, the first support wheel 200A is arranged to contact the ground surface 250 only when the unicycle is titled significantly from vertical (e.g. by more than 15°). This may, for example, occur when a user attempts to turn the unicycle sharply and thus intentionally leans the unicycle sideways by a significant amount. In such a situation, first support wheel 200A can act as a support for preventing the unicycle from falling over in a sideways fashion and also provide a pivot point for enabling the unicycle to turn in a tighter fashion (e.g. with a smaller turning circle radius) than would otherwise be possible).

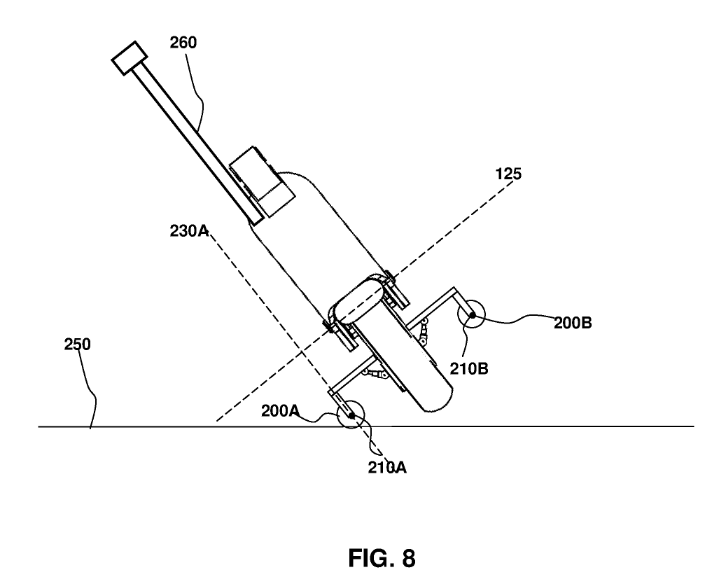

A modification to the embodiment of FIGS. 6-7 is shown in FIG. 8. The embodiment of FIG. 8 is similar to that of FIGS. 6-7. However, the embodiment of FIG. 8 further comprises a telescopic retractable handle 260. The retractable handle is adapted to be movable between a retracted configuration (not illustrated) and an extended configuration (depicted in FIG. 8). In the retracted configuration, substantially all of the handle 260 is positioned within the body or housing 110 of the unicycle device. In this way, only a small portion may be grabable/gripable by user so that the handle 260 can then be moved to the extended configuration. This helps to minimise or reduced the size of the unicycle device when the handle is in the retracted configuration. By grabbing and puling on handle 260 when in its retracted configuration, a user can move the handle 260 to the extended configuration wherein it projects upwardly from the top of the housing 110 (as illustrated in FIG. 8). In the extended configuration, the handle 260 forms/provides an elongate element that extends upwardly from the casing 110 of the unicycle device so as to provide a user-holdable portion of the unicycle device that is positioned closer to a normal hand position of a user (when compared to the position of the handle in the retracted configuration).

Using the handle 260, and as depicted in FIG. 8, a user can tilt the unicycle device sideways so that the first support wheel 200A contacts the generally horizontal ground/supporting surface 250 and so that the wheel 120 is separated vertically from the generally horizontal ground/supporting surface 250. In this way, the unicycle device can be supported solely on the first support wheel 200A so that the main wheel 120 is raised upwards from the ground 250 and does not contact the ground 250. The first support wheel 200A can then be used to convey the unicycle in a direction that differs from the running direction of the primary wheel, for example in a lateral/sideways direction. Thus, the use can pull or push the unicycle along using the handle 260 (like two-wheeled luggage for example).

Also, when being conveyed on the first support wheel 200A as shown in FIG. 8, the gyroscope or accelerometer system 170 can be used to sense forward and backward tilt of the device (in the running direction of the wheel 120) and regulate the motor 155 to rotate the wheel about the central axis 125 accordingly to keep the device balanced on the first support wheel 200A. In other words, by controlling rotation of the wheel 120 when the device is being conveyed on the first support wheel 200A and the wheel is not in contact with the ground 250 (as shown in FIG. 8), a pendulum-like effect can be used to maintain or improve the balance of the device. In this way, the user is assisted in balancing the unicycle as it is pulled/pushed along using the handle 260. Thus, the embodiment may employ a pendulum-like effect to enable the unicycle to self-regulate its balance about the supplementary axis 230A when supported/conveyed solely by the first support wheel 200A (and not just in the upright fore-aft plane that the gyroscope or accelerometer system 170 is normally used for).

Thus, the balance control system can be adapted to maintain pivotal balance of the unicycle device about an inclined supplementary axis 230A that is titled from vertical by controlling rotation of the wheel 120 when the unicycle device is supported only by the at least one auxiliary support and the wheel 120 is not in contact with the ground surface 250.

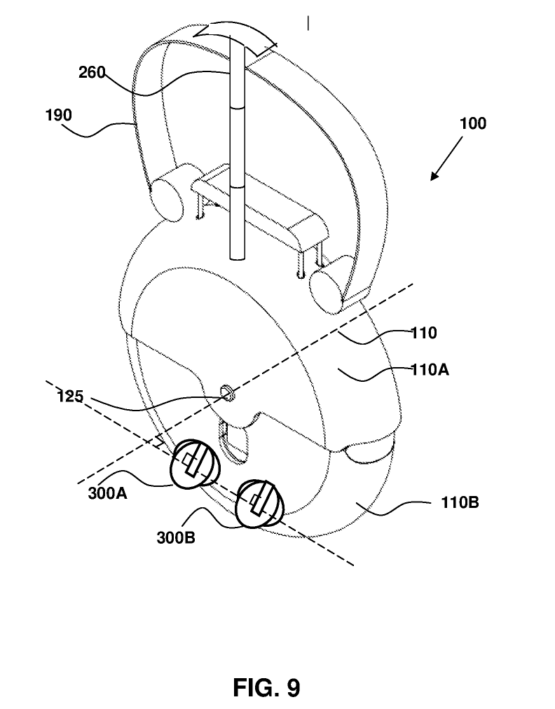

A modification to the embodiment of FIGS. 1-5 is shown in FIG. 9. The embodiment of FIG. 9 is similar to that of FIGS. 1-5. However, in the embodiment of FIG. 9, the auxiliary support comprises first 300A and second 300A support wheels that are coupled to the lower portion of the casing 110B. The embodiment of FIG. 9 also comprises a telescopic retractable handle 260 (similar to that of FIG. 8)

The first 300A and second 300A support wheels are adapted to be movable between a stowed configuration (not illustrated) and an active position (shown in FIG. 9).

In the stowed configuration, the first 300A and second 300A support wheels are retracted into the casing 110B of the unicycle device (e.g. stowed away) so that they do not extend outwardly from the side of the lower portion of the casing 110B. In the active configuration (as shown in FIG. 9), the first 300A and second 300A support wheels are arranged so as to be positioned or project outside of the side of the lower portion of the casing 110B. Thus, in the active configuration, the first 300A and second 300A support wheels are adapted to contact the ground when the unicycle is tilted from vertical by a predetermined significant amount.

In other words, in the stowed configuration, the first 300A and second 300A support wheels are arranged so that they do not contact the ground when the unicycle is tilted from vertical by the amount at which the first 300A and second 300A support wheels would contact the ground when in the active configuration.

Thus, the first 300A and second 300A support wheels are movable between: (i) a stowed configuration wherein they are retracted inside the casing 110 of the unicycle device; and (ii) an active configuration, wherein they are positioned or project outwardly from/of the side of the casing 110. Accordingly, the first 300A and second 300A support wheels may be foldable into a stowed configuration that narrows the profile of the unicycle device. In use, the first 300A and second 300A support wheels may be moved to the active configuration.

The retractable handle is adapted to be movable between a retracted configuration (not illustrated) and an extended configuration (depicted in FIG. 9). In the retracted configuration, substantially all the handle 260 is positioned within the casing 110 of the unicycle device. In this way, only a small portion may be grabable/gripable by user so that the handle 260 can then be moved to the extended configuration. This helps to minimise or reduced the size of the unicycle device when the handle is in the retracted configuration. By grabbing and puling on handle 260 when in its retracted configuration, a user can move the handle 260 to the extended configuration wherein it projects upwardly from the top of the housing 110 (as illustrated in FIG. 9).

In this embodiment, the retractable handle 260 is adapted to move the first 300A and second 300A support wheels between the stowed configuration and the active position when it is moved between the retracted configuration and extended configuration. In other words, the handle 260 is adapted to move the first 300A and second 300A support wheels between the stowed configuration and the active position.

More specifically, a simple mechanical lever arrangement is used to move the first 300A and second 300A support wheels between the stowed configuration and the active position. When a user pulls the handle 260 to move it from the retracted configuration to the extended configuration, the handle moves a lever (not visible) which causes the first 300A and second 300A support wheels to pivot about an axis which moves them from the stowed configuration to the active position. Conversely, when a user pushes the handle 260 downwardly towards the casing 110 to move it from the extended configuration to the retracted configuration, the handle moves the lever (not visible) in the opposite direction which causes the first 300A and second 300A support wheels to pivot about an axis which moves them from active position to the stowed configuration.

In the extended configuration, the handle 260 forms/provides an elongate element that extends upwardly from the casing 110 of the unicycle device so as to provide a user-holdable portion of the unicycle device that is positioned closer to a normal hand position of a user (when compared to the position of the handle in the retracted configuration).

Using the handle 260, a user can move the first 300A and second 300A support wheels to the active position and then tilt the unicycle device sideways so that the first 300A and second 300A support wheels contact the generally horizontal ground/supporting surface 250. In this way, the unicycle device can be supported solely on the first 300A and second 300A support wheels. The first 300A and second 300A support wheels can then be used to convey the unicycle in a lateral/sideways direction. Thus, the user can pull or push the unicycle along using the handle 260 (like two-wheeled luggage for example).

It will be appreciated that other embodiments may employ other actuator arrangements and/or mechanisms for moving the auxiliary support between a stowed and active configuration. By way of example, a telescoping actuator arrangement may be employed to move the auxiliary support between a stowed configuration and an active position. Also, an actuator may comprise any suitable arrangement for affecting or driving movement of the auxiliary support(s). For example, embodiments may comprise one or more hydraulic, electric or mechanical actuators adapted to move the auxiliary support(s) between an extended and retracted configuration.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1. A self-balancing powered unicycle device, comprising:
a single primary wheel configured to rotate about a primary axis of rotation;
a balance control system configured to maintain fore-aft balance of the unicycle device by controlling rotation of the single primary wheel;
a foot platform for supporting a user of the unicycle device; and
at least one auxiliary support configured to rotate about an auxiliary axis of rotation, wherein the auxiliary axis of rotation is angled with respect to the primary axis of rotation.

2. The self-balancing powered unicycle device of claim 1, wherein the at least one auxiliary support is configured to only contact a ground supporting surface when the single primary wheel is tilted from vertical by more than 10 degrees.

3. The self-balancing powered unicycle device of claim 1, wherein the auxiliary axis of rotation is configured to be rotatable about a supplementary axis that is angled with respect to the auxiliary axis of rotation.

4. The self-balancing powered unicycle device of claim 2, wherein the auxiliary axis of rotation is configured to be rotatable about the supplementary axis by 360°.

5. The self-balancing powered unicycle device of claim 3, wherein the supplementary axis is substantially perpendicular to the auxiliary axis of rotation.

6. The self-balancing powered unicycle device of claim 1, wherein the auxiliary axis of rotation is substantially perpendicular to the primary axis of rotation.

7. The self-balancing powered unicycle device of claim 1, wherein the at least one auxiliary support comprises a substantially spherical or circular wheel.

8. The self-balancing powered unicycle device of claim 1, wherein the at least one auxiliary support is configured to be movable between a stowed configuration and an active position.

9. The self-balancing powered unicycle device of claim 1, further comprising a retractable handle configured to be movable between a retracted configuration and an extended configuration.

10. The self-balancing powered unicycle device of claim 9 wherein the retractable handle is configured to be movable between a retracted configuration and an extended configuration so as to move the at least one auxiliary support between a stowed configuration and a active position.

11. The self-balancing powered unicycle device of claim 1, wherein the at least one auxiliary support is mounted on the foot platform.

12. The self-balancing powered unicycle device of claim 1, wherein the at least one auxiliary support comprises first and second rotatably mounted elements configured to rotate about first and second auxiliary axes of rotation, respectively, and the first and second auxiliary axes of rotation are angled with respect to the primary axis of rotation.

13. The self-balancing powered unicycle device of claim 1, wherein the balance control system configured to maintain pivotal balance of the unicycle device about an inclined axis that is titled from vertical by controlling rotation of the single primary wheel when the unicycle device is supported only by the at least one auxiliary support.

14. (canceled)
